(19) United States
(12) Patent Application Publication
(10) Pub. No.: US 2024/0197569 A1
(43) Pub. Date: Jun. 20, 2024

(54) SMART PILL DISPENSER

(71) Applicant: Express Scripts Strategic Development, Inc., St. Louis, MO (US)

(72) Inventor: Robert E. Hoffman, Linden, IN (US)

(21) Appl. No.: 18/541,631

(22) Filed: Dec. 15, 2023

Related U.S. Application Data
(60) Provisional application No. 63/432,880, filed on Dec. 15, 2022.

(51) Int. Cl. A61J 7/00; A61J 1/03; A61J 1/14; A61J 7/02

(52) U.S. Cl. CPC A61J 7/0069; A61J 1/03; A61J 1/1468; A61J 7/02; A61J 2200/30

(57) ABSTRACT

One aspect of the present disclosure is related to a medication dispensing device. The medication dispensing device includes a housing and a tray. The tray carries a plurality of pods with interiors that can contain pills and is moveable between an open position where the pods are exposed to a user and a closed position where the pods are not exposed to the user. At least one of the pods is at least partially made of an elastomeric material that can deflect to open a passage. When the tray is in the open position, the pods are able to be individually opened to either receive pills or to dispense pills. The medication dispensing device also includes a controller that is configured to monitor the insertion of pills into the pods and the dispensing of pills out of the pods.

### CROSS-REFERENCE TO RELATED APPLICATION

This application claims priority to U.S. Provisional App. No. 63/432,880, filed on Dec. 15, 2022, and entitled “SMART PILL DISPENSER,” the entire contents of which is herein incorporated by reference.

### BACKGROUND

### 1. Field

The present disclosure is related generally to a medication dispensing device which contains multiple different types of pills and can dispense those pills to a user.

### 2. Related Art

Many pharmaceutical regimens require a user to take multiple different types of medications at different times. Generally, greater the variation in the dosing events and/or the greater the number of different medications leads to diminished medication compliance. In other words, the more complicated a dosing regimen is, the less likely it will be correctly followed by the user. To counteract this problem, some products have been developed to improve medication compliance.

### SUMMARY

A medication dispensing device is described herein that is configured to dispense one or more different types of solid medications for a user (e.g., a patient, a caregiver or the like). The dispensing device is conveniently contained within a compact package that can be stored in a convenient location within a user's home, such as on a kitchen counter, under a shelf, or on a bedside table. The medications are frequently hereinafter referred to as pills. However, it should be appreciated that this term is intended to include many types of medications that can be singulated may be employed. Such medications may include, for example, solid medications (such as tablets, gel caps, capsules or the like, e.g., non-liquid medicines) or non-solid medications in containers (such as single use eye drop containers or other single use liquid medications).

In an example, the medication dispensing device improves medication compliance by allowing the user to conveniently store a large supply of different pills in a single, convenient device, which not only stores the pills in a sorted manner but also assists the user with the user's medication schedule thereby preventing either missed doses or double doses. As discussed in further detail below, in operation, the dispensing device automatically dispenses pills either according to a preset schedule or an on-demand request by the user. A sensor system can be used to sense when the pill receptacle is available to the user. The sensor system may also sense when a pill is removed from the pill receptacle.

One aspect of the present disclosure is related to a medication dispensing device. The medication dispensing device includes a housing and a tray. The tray carries a plurality of pods with interiors that can contain pills and is moveable between an open position where the pods are exposed to a user and a closed position where the pods are not exposed to the user. When the tray is in the open position, the pods are able to be individually opened to either receive pills or to dispense pills. The medication dispensing device also includes a controller that is configured to monitor the insertion of pills into the pods and the dispensing of pills out of the pods.

According to another aspect of the present disclosure, at least one of the pods has a bottom piece that is made of an elastomeric material and a top piece, wherein the bottom piece includes at least one slit, and wherein the bottom piece is configured such that that the application of a downward force on the top piece can cause the at least one slit to open to expose a passage to dispense at least one pill out of the interior of the pod through the passage.

According to yet another aspect of the present disclosure, the at least one slit in the bottom piece is at least two slits that extend generally perpendicular to one another. The application of the downward force on the top piece can cause all of the at least two slits to open to expose the passage.

According to still another aspect of the present disclosure, the top piece of at least one of the pods is at least partially made of an elastomeric material and includes at least two projections that protrude downwardly into the interior of the pod to engage a sidewall of the bottom piece. The application of the downward force on the top piece can cause the at least two projections to press on the sidewall of the bottom piece to open the passage.

According to a further aspect of the present disclosure, the at least two projections on the top piece includes four projections that have lengths that are configured to dispense one pill out of the passage of the bottom piece per downward force on the top piece.

According to yet a further aspect of the present disclosure, a first pod of the plurality of pods contains a first type of pill, and a second pod of the plurality of pods contains a second type of pill that has a different size than the first type of pill. The projections of the first pod have different lengths than the projections of the second pods.

According to still a further aspect of the present disclosure, the tray further includes a chute that is positioned vertically below all of the plurality of pods to collect the pills that are dispensed out of the pods.

According to another aspect of the present disclosure, for at least one of the pods, the top piece can be at least partially removed from the bottom piece to present the interior of the pod from vertically above the pod.

According to yet another aspect of the present disclosure, the medication dispensing device further includes at least one light emitter and includes at least one light detector that is in electrical communication with the controller and is configured to detect pill insertion and dispensing events into and out of the plurality of pods.

According to still another aspect of the present disclosure, the at least one light emitter and the at least one light detector are positioned vertically below the plurality of pods.

Another aspect of the present disclosure is related to a pod for a medication dispensing device. The pod includes a bottom piece that is made of an elastomeric material and holds a plurality of medications. The bottom piece also includes at least one slit that can be opened to present a passage. The pod further includes a top piece that is connected with the bottom piece. The top and bottom pieces enclose an interior of the pod. The top piece includes a plurality of projections that extend into the interior and contact a sidewall of the bottom piece. The top and bottom pieces are configured such that an application of a downward force on the top piece causes the projections to deform the bottom piece to open the slit and present the passage.

According to another aspect of the present disclosure, the top piece is at least partially made of an elastomeric material.

According to yet another aspect of the present disclosure, the at least one slit in the bottom piece includes two slits that extend generally perpendicular to one another.

According to still another aspect of the present disclosure, the top piece can be at least partially removed from the bottom piece to present the interior of the pod from vertically above the pod.

According to a further aspect of the present disclosure, the top piece is at least partially made of an elastomeric material.

Yet another aspect of the present disclosure is related to a method of dispensing medications from a medication dispensing device. The method includes the step of preparing the medication dispensing device. The medication dispensing device includes a plurality of pods that are disposed within a tray. At least one of the pods includes a bottom piece that is made of an elastomeric material and holds a plurality of medications and includes at least one slit that can be opened to present a passage. The at least one pod also includes a top piece that is connected with the bottom piece. The top and bottom pieces enclose an interior of the pod. The top piece includes a plurality of projections that extend into the interior and contact a sidewall of the bottom piece. The method further includes the step of applying a downward force to the top piece such that the projections deform the bottom piece of the at least one pod to open the slit and present the passage. The method also includes the step of automatically dispensing at least one pill out of the at least one pod through the passage.

According to another aspect of the present disclosure, the step of automatically dispensing at least one pill out of the at least one pod through the passage includes singulating and dispensing only a single pill out of the at least one pod through the passage.

According to yet another aspect of the present disclosure, the top piece is at least partially made of an elastomeric material.

According to still another aspect of the present disclosure, the at least one slit in the bottom piece includes two slits that extend generally perpendicular to one another.

According to a further aspect of the present disclosure, the tray further includes a chute that is positioned below the plurality of pods to catch the pills dispensed out of the pods.

### BRIEF DESCRIPTION OF THE DRAWINGS

These and other features and advantages of the disclosure will become more readily appreciated when considered in connection with the following description of the presently preferred embodiments, appended claims and accompanying drawings, in which:

FIG. 1 is a medication dispensing device according to an example embodiment;

FIG. 2 is medication dispensing device in a second state according to an example embodiment;

FIGS. 3A-3C show examples of a tray with storage receptacles according to various embodiments;

FIGS. 4A-4B show examples of a tray with storage receptacles according to a various embodiments;

FIG. 5 shows a partial view of the medication dispenser to an example embodiment;

FIGS. 6A-6b show examples of A partial view of the medication dispenser to an example embodiment;

FIG. 7 shows a partial view of the medication dispenser according to an example embodiment;

FIG. 8 shows a plot of sensor signal levels according to an example embodiment;

FIG. 9 shows a partial view of the medication dispenser according to an example embodiment;

FIG. 10A shows a schematic view of a system using the medication dispenser according to an example embodiment;

FIG. 10B shows a shows a schematic view of a system using the medication dispenser according to an example embodiment

FIG. 11 shows a schematic view of a system using the medication dispenser according to an example embodiment;

FIG. 12 is a perspective elevation view of a second embodiment of the medication dispensing device;

FIG. 13 is a cross-sectional view of the medication dispensing device of FIG. 12;

FIG. 14 is a bottom elevation view of a pod of the second exemplary embodiment of the medication dispensing device;

FIG. 15A is a cross-sectional view of the pod of FIG. 14;

FIG. 15B is a cross-sectional view of the pod of FIG. 15A during a dispensing operation; and

FIG. 16 is a method showing steps in a dispensing operation according to an example embodiment.

### DESCRIPTION OF THE ENABLING EMBODIMENT

The present description relates to dispensing of medication to patients, e.g., in an at home setting. It is desirable to improve medication adherence of the patient and one such way to improve adherence is to make it easier to dispense a drug or multiple drugs to the patient or by the patient. A product which seeks to improve medication adherence is a pill container which includes a plurality of individual chambers which can contain different medications all in one container, which can be manually opened and closed. However, a few problems with this product identified by the present inventor are that it is cumbersome to load and may not greatly improve adherence because the user may simply forget to take a dose. Another problem with this product is that in some jurisdictions, medications can only be transported in approved containers, which are labeled to identify what medications are contained therein. Such labels are not common in these known types of multi-chambered pill containers. Hence, the patient must load such multi-chambered pill containers themselves. This may reduce adherence. Accordingly, the present disclosure addresses these issues and others with a new medication dispenser.

Referring to the Figures, wherein like numerals indicate corresponding parts throughout the several views, one aspect of the present disclosure is related to a medication dispensing device 20 that is configured to automatically dispense one or more different types of solid medications for a user (e.g., a patient, a caregiver or the like). The dispensing device 20 is conveniently contained within a compact package that can be stored in a convenient location within a user's home, such as on a kitchen counter, under a shelf, or on a bedside table. The medications are frequently hereinafter referred to as pills 22a-d; however, it should be appreciated that this term is intended to cover many types of medications that can be singulated, such medications may include, for example, solid medications (such as tablets, gel caps, capsules or the like, e.g., non-liquid medicines) or non-solid medications in containers (such as single use eye drop containers or other single use liquid medications).

The medication dispensing device 20 improves medication compliance by allowing the user to conveniently store a large supply of different pills 22a-d in a single, convenient device. Embodiments of the device not only store the pills 22a-d in a sorted manner but also assists the user with the user's medication schedule thereby preventing either missed doses or double doses, i.e., non-compliance to a medication regimen. As discussed in further detail below, in operation, the dispensing device 20 automatically dispenses pills 22a-d either according to a preset schedule or an on-demand request by the user.

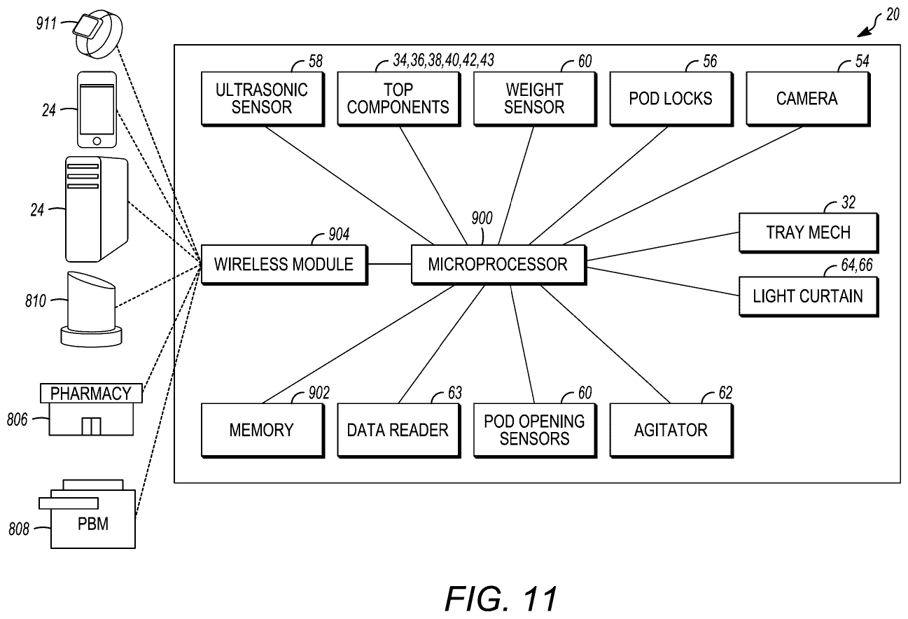

As also discussed in further detail below, the medication dispensing device 20 is a smart device in that it knows what types of pills 22a-d are contained within it and the quantities of each of those pills 22a-d and is able to communicate this and other information to a user's external device 24 (schematically illustrated in FIG. 11—such as a smart phone, a tablet, a personal, computer, a smart watch, a dedicated unit, a voice assistant, a host, or any suitable type of electronic device). A smart pill dispenser includes sensors, electrical processing circuitry, memory in communication with each other to track medication dispensing and communicate with other devices, e.g., wirelessly. The medication dispensing device 20 is able to receive information from the external device 24. The various containers in the dispensing device 20 may contain a range of different types of pills 22a-d, including both prescription and non-prescription medications, which can be communicated from the external device to the dispensing device 20. The dispensing device 20 may also communicate with other authorized devices, e.g., a caregiver device, a family member device and the like. This can work to notify another authorized person of the dispensing of the pills 22a-d from the dispensing device 20 so that another party (such as a doctor or a family member) can monitor the user's adherence to their medication regimen. The dispensing device 20 can also communicate via the internet with a telehealth provider to provide that provider with a patient's medication regimen and their compliance to that regimen.

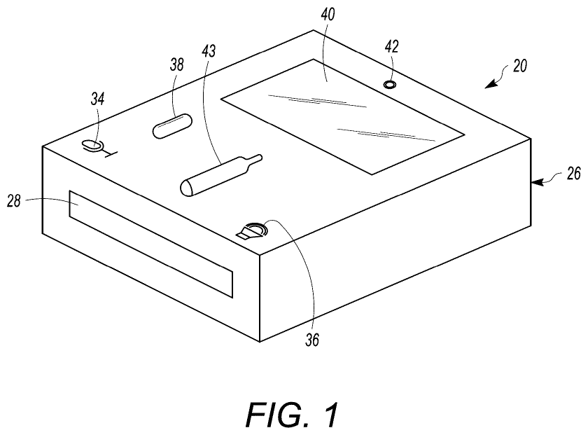

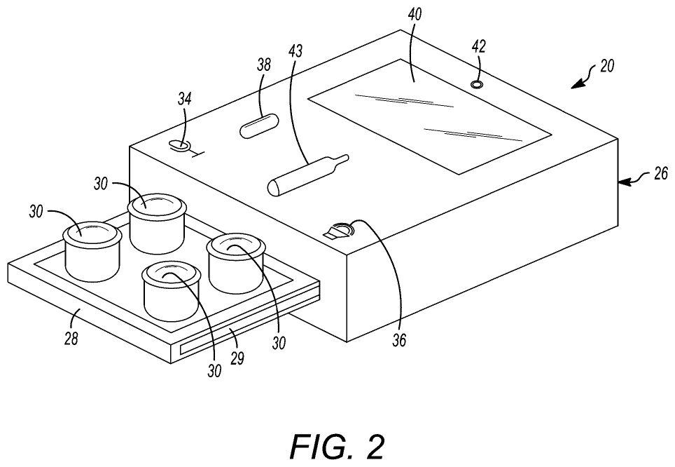

Referring now to FIGS. 1 and 2, the dispensing device 20 includes a housing 26 with a partially open interior. A tray 28 is retractable into and out of the interior through an opening in the housing 26. The tray 28 retains a plurality of separate medication containers or pods 30 that contain the pills 22a-d. For example, in FIG. 1, the tray 28 is in a retracted position within the housing 26 such that the pods 30 containing the pills 22a-d are not accessible. The retracted position is for storage of the medications. In FIG. 2, the tray 28 is in an extended position such that the pods 30 are presented to the user for access. When the tray 28 is in the retracted position, a flat outer surface of the tray 28 is generally flush with a front surface of the housing 26 and is sealed against the housing 26 to block all or substantially all outside light from entering the open interior, to control the atmospheric environment within the open interior to preserve the pills 22a-d contained therein, and also to improve verification of the pills 22a-d contained within the dispensing device 20, as discussed in further detail below. In the exemplary embodiment, the tray 28 is movable into and out of the housing 26 from a front surface of the housing 26. However, in some embodiments, the tray 28 can extend into and out of a side surface or a back surface of the housing 26.

In the exemplary embodiment, the tray 28 has a pair of slides 29 on its opposite sides, and the interior of the housing 26 has an additional pair of slides that cooperate with the slides 29 on the tray 28 to facilitate the movement of the tray 28 into and out of the housing 26. In the exemplary embodiment, an electronic motor 32 (schematically illustrated in FIG. 11) actuates the movement of the tray 28 into and out of the housing 26, e.g., on the slides 29. In some embodiments, the movement of the tray 28 into and out of the housing 26 can be manual. In some alternate embodiments, rather than sliding linearly into and out of the housing, the tray could be hingedly connected with the housing and can swing about a pivot axis (e.g., a vertical axis positioned in the housing) into and out of the housing.

The housing 26 has a top surface that includes at least one machine-to-human interaction device or human machine interface (HMI). In the exemplary embodiment, the machine-to-human interaction devices include a speaker 34, a microphone 36, an identification confirmation device (such as a fingerprint scanner 38), a display screen 40, and a camera 42. In some embodiments, the housing 26 may further include one or more buttons, which can provide additional means by which a user can communicate with the dispending device 20. The display screen 40 may be, for example, a liquid crystal display (LCD) or light emitting diode (LED) display and preferably includes touch screen interfaces to allow the user to input information into the dispensing device 20 through the display screen 40. However, any suitably screen type may be employed.

The display screen 40 and camera 42 on the housing 26 together allow the user to conduct a telehealth, videoconference appointment with a medical care provider through the dispensing device 20. During the telehealth appointment, the medication dispensing device 20 can automatically and electronically communicate the user's medication regimen and the user's adherence to that medication schedule to the medical care provider to allow the medical care provider to have access to this data and provide better service to the user. Also, during the telehealth appointment, the medical care provider can adjust the user's medication regimen that is programmed into control circuitry or a controller (discussed in further detail below) of the medication dispensing device 20.

The speaker 34, the microphone 36, and the display screen 40 are a few ways (other ways discussed in further detail below) for a user to interact with the dispensing device 20. Such interactions may allow the user to, inter alia, check the quantities of the pills 22a-d contained in the dispensing device 20, request a pill 22a-d, adjust an automatic dispensing schedule, and/or pair the dispensing device 20 with an external device 24, such as the user's smartphone. When the dispensing device 20 determines that the pill count in any of the pods 30 is below a set (e.g., predetermined) threshold (e.g., five pills or a time period, such as a week or less, or two weeks or less of any of the pills 22a-d remain), an alert can be displayed on the display screen 40 and/or the alert can be broadcast to the user through the speaker 34 or otherwise communicated to the user through the external device 24. The display screen 40 can also provide instructions to the user on how to accomplish basic tasks with the medication dispensing device 20, e.g., how to open the tray 28, how to open the pods 30 to dispense the pills 22a-d, how to refill the pods 30 with pills 22a-d, etc.

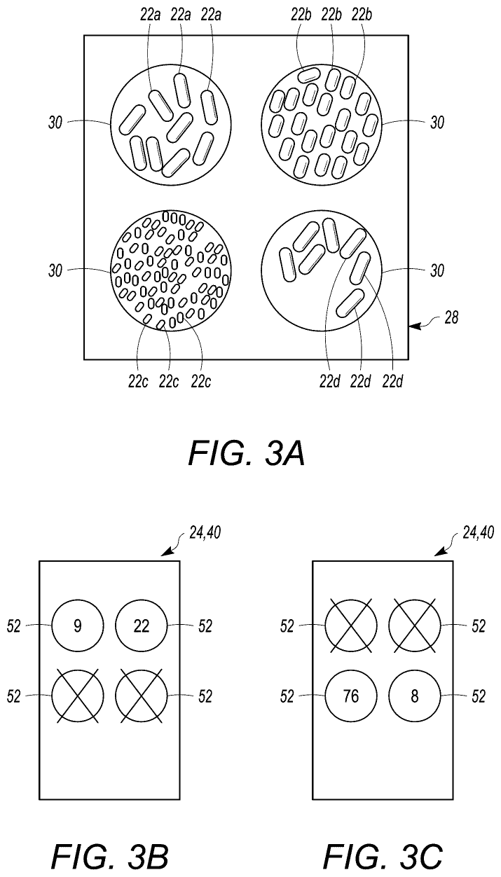

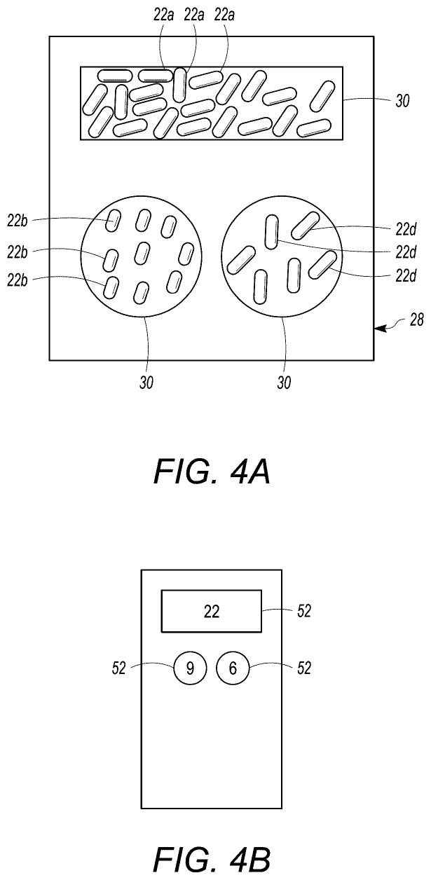

In the embodiment of FIG. 3A, the pods 30 are arranged on the tray 28 in a two-by-two array such that there are four pods 30 in total. As illustrated, the different pods 30 on the tray 28 can contain different types of pills 22a-d. In some cases, two or more of the pods 30 can contain the same types of pills 22a-d. For example, a first type of pill 22a can be found in a first pod 30, a different second type of pill 22b can be found in a second pod 30, a still different third type of pill 22c can be found in a third pod 30, and a fourth different type of pill 22d can be found in a fourth pod 30. In some embodiments, the pods 30 could be arranged in a different pattern (for example, a three-by-three array or a four-by-four array), and the pods 30 can have similar or different shapes and sizes. The arrangement of the pods 30 on the tray 28 can also be altered or changed by the user based on changes to the user's medication regimen. For example, in FIG. 4A, the top row of pods 30 on the tray 28 has been replaced with a single, much larger pod 30′ that can contain more and/or larger types of pills 22a-d than the smaller pods 30 found in the embodiment of FIG. 3A. The user can change the arrangement of pods 30 between these two example patterns and many other patterns according to the user's specific medication regimen and preferences.

In some embodiments, the pods 30 can be pre-filled in a pharmacy setting and inserted by the user into the medication dispensing device 20. In an example, the pods can be replaced by a pod filled at a pharmacy. The pod can include a drug label. Example drug labels are described in U.S. Pat. Nos. 11,848,084; 11,775,824; D861,796, and D861,795, which are hereby incorporated by reference. In an example, the pod can be placed in a container that is labeled such that the user can remove the pod from the labeled container and insert the pod in the dispensing device 20. The pod can include a machine-readable code that is read in the dispensing device 20 that the device 20 can associate the pod with the downloaded drug information. The drug information downloaded to the dispensing device 20 can be associated with the pod inserted into the dispensing device. In some other embodiments, the user can fill the pods 30 with the appropriate pills 22a-d according to their medication regimen.

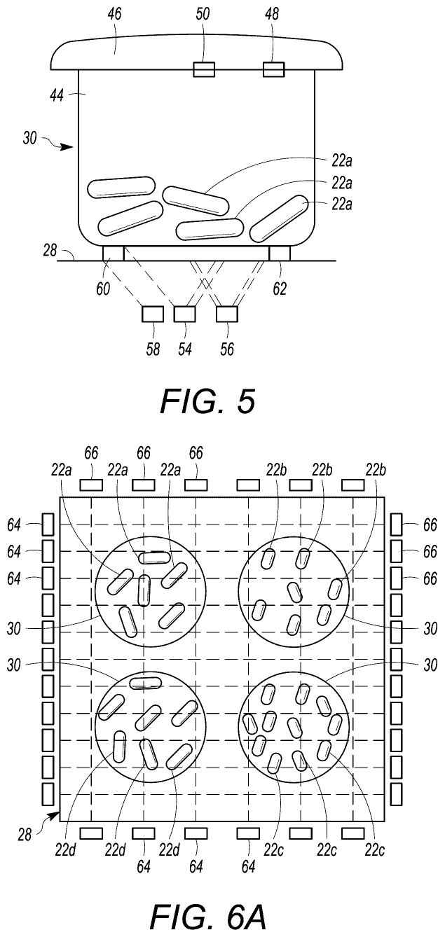

As illustrated in FIG. 5, each pod 30 on the tray 28 has a receptacle portion 44 and a lid 46 that is hingedly connected with or removable from the receptacle portion 44. The lids 46 of the pods 30 can be individually and electronically locked by way of a locking mechanism 48 so that the pills 22a, 22b contained in the pods 30 can only be accessed when approved, for example, according to the user's medication regime. In an example embodiment, for each pod 30, the lid 46 is locked with the receptacle portion 44 via an electromagnet 48 that can be electronically activated and deactivated by a controller, which is discussed in further detail below. This improves the user's medication adherence by preventing the user from mistakenly accessing and taking the wrong type of pill 22a-d or from taking a pill 22a-d off-schedule. Some of the locking mechanisms 48 can be unlocked on demand and only after a predetermined period after the last opening. For example, a pod 30 containing a pain reduction pill 22a-d can be configured to open on demand but not more frequently than once every six hours. The locking mechanisms 48 can be individually and electronically activated and deactivated by a controller that includes a processor or microprocessor 900 (schematically illustrated in FIG. 11) according to the user's medication regimen.

In some embodiments, each pod 30 includes an opening sensor 50 that electronically detects when the respective pod 30 is opened or closed. Using the opening sensors 50, the medication dispensing device 50 can then sense each opening and closing event of any of the pods 30 to log each medication dispensing event and track the user's adherence to their medication regimen. In an exemplary embodiment, the opening sensor 50 is a magnetic sensor.

In some embodiments, the dispensing device 20 may contain medications for multiple users, e.g., different members of a family or household. For example, one or more of the pods 30 can contain pills 22a-d for only a first user and one or more of the pods 30 can contain pills 22a-d only for a second user. One or more of the pods 30 can also contain pills 22a-d for both of the first and second users. The medication dispensing device 20 also includes a security system that utilizes identification verification techniques (for example, the fingerprint scanner 38, a facial recognition sensor in the camera 42 on the housing 26, some other identification verification device on the user's external device 24, a passcode on the display screen 40, a password on the display screen 40, a positive voice identification through the microphone 36, etc.) to confirm a user's identity prior to unlocking a particular pod 30 and allowing the user to access the pills 22a-d contained therein. In other words, the combination of the electronic locking mechanism 48 on each pod 30 and the identification verification techniques allows only the pods 30 assigned to a particular user to unlock while the pods 30 assigned to another user or other users remain locked and inaccessible to the user who is operating the medication dispensing device 20 at a given time. In some embodiments, the medication dispensing device 20 may be configured to allow the pods 30 to be dedicated to three or more users.

In the exemplary embodiment, the pods 30 are held in the respective openings of the tray 28 in a detachable manner such that any of the pods 30 can be manually and individually removed from the tray 28, e.g., when the pills 22a-d in a given pod 30 are depleted. Thus, the pods 30 can be removed from the tray 28 and replaced with other pods 30, for example, pods 30 that have been filled with pills 22a-d in a pharmacy. In an example embodiment, the pods 30 are resiliently engaged by the tray 28 by one or more spring-like features. When a pod 30 is properly inserted into a slot of the tray 28, the spring-like features may produce an audible “snapping” sound to provide the user with a positive affirmation that the insertion of the pod 30 into the tray 28 was successful.

In one embodiment, the pods can be disposable cups that can be filled with pills in a dosing filler system that may be located within a high-volume pharmacy. In some such embodiments, each pod may contain a specific dose of multiple different kinds of pills that the user is to take together at a specific time rather than multiple doses of just one type of pill. For example, one pod can contain all of the different types of pills that a user is to take on a given morning. Such a dosing filler system may include an order processing device that receives orders, a container transport system that transports a plurality of receptacles, such as the pods, to one or more pill dispensers, which fill the pods with the appropriate types and quantities of pills. One example of such a dosing filler system is taught in U.S. Pat. No. 11,424,016, which is herein incorporated by reference.

In this embodiment, the tops of the pods 30 open so a user can reach into the pods 30 from above when the tray 28 is in the extended position to retrieve the pills 22a-d. In some other embodiments that are discussed in further detail below, the pods are configured to singulate and dispense the pills downwardly, e.g., onto a counter, into a chute, or into some kind of retrieval tray.

As illustrated in FIGS. 3A-C, 4A, and 4B, an app on the user's external device 24 or on the display screen 40 includes a graphical user interface with a plurality of icons 52 that are arranged in the same pattern as the pods 30 on the tray 28. The icons 52 can be color coordinated or can otherwise identify which pods 30 belong to which user. For example, the graphical user interface of FIG. 3B can be displayed only to a first user who is associated with only the top row of pods 30, and the graphical user interface of FIG. 3C can be displayed only to a second user who is associated only with the second rows of pods 30.

In an example embodiment, the icons 52 on the graphical user interface can change appearance based on a status of the pills 22a-d in the pods 30 and/or based on the user's medication regimen. In one example embodiment, an icon 52 for one of the pods 30 may turn red if that pod 30 is empty, may turn orange if the user is late to take the pill 22a-d in that pod 30 according to the user's medication regimen, may turn green if it is time for the user to take the pill 22a-d in that pod 30, etc. In other embodiments, the color designations can vary from those of this embodiment. In some other embodiments, rather than the colors of the icons 52 changing, the shapes and/or sizes of the pods 30 could change. Also, in the exemplary embodiment, each icon 52 includes indicia that identifies a number of pills 22a-d that is currently contained within the respective pod 30 and/or a number of pills 22a-d that the user is to remove from the appropriate pod 30 during a next dispensing event. The indicia is automatically updated with every filling and dispensing event, as discussed in further detail below. In some embodiments, the icons 52 can be selected to display information pertaining to the type of pill 22a-d contained within the associated pod 30. Such information could include the type of pill 22a-d, the user's schedule for that pill 22a-d, and any other instructions pertaining to that type of pill 22a-d.

The arrangement of the icons 52 can be automatically adjusted when the arrangement of the pods 30 on the tray is altered. For example, the arrangement of the icons 52 in FIG. 4B is different than the arrangement in FIGS. 3B and 3C to align with the arrangement of pods in FIG. 4A.

The medication dispensing device 20 includes control, processing circuitry that is configured to identify the types of pills 22a-d in each of the pods 30 and maintain a constant pill count for each of the pods 30. For example, in the exemplary embodiment, in an interior of the housing 26, beneath each pod 30, the medication dispensing device 20 includes at least one camera 54, at least one light source 56, at least one ultrasonic sensor 58, a weight sensor 60 (scale), and an agitator 62. The receptacle portion 44 and the lid 46 of the pod 30 are made of a transparent material so that the camera 54 is able to view the pills 22a contained within the pod 30 through the material of the pod 30 when the pod 30 is illuminated by the light source 56.

In operation, when the tray 28 is in the retracted position illustrated in FIG. 1, the light source 56, camera 54, ultrasonic sensor 58, and weight sensor 60 are activated to image and scan the pills 22a contained in the pod 30. More specifically, images generated by the cameras 56 can be scanned to determine the shape, size, and etchings of the pills 22a. The ultrasonic sensor 58 scans the pod 30 to generate a sonogram of the pod 30 and its contents to further confirm that the types of pills 22a in the pod 30 are the correct pills 22a for that pod 30. The medication dispensing device 20 automatically compares the weight measurement sensed by the weight sensor 60, the images captured by the cameras 54, and the sonogram generated by the ultrasound sensor 58 against an artificial intelligence database to verify both the type and quantity of pills 22a contained in the pod 30. Specifically, the medication dispensing device 20 analyzes the shapes, sizes, and any etchings on the pills 22a and compares those readings to others in the artificial intelligence database. The artificial intelligence database is preferably maintained in a remote server and is periodically downloaded to a memory 902 (shown in FIG. 11 and discussed in further detail below) in the dispensing device 20 to improve performance of the dispensing device 20. The dispensing device 20 also preferably uploads images and sonograms that are generated by the cameras 54 and the ultrasound to the database to improve the database. Based on the measured weight by the weight sensor 60 and known weights of an empty pod 30 and of each pill 22a contained therein (once the medication type has been determined), the medication dispensing device 20 is thus able to determine a pill count for the pod 30. Both the type and quantity of the pills 22a in the pod 30 can also be verified using images captured by the camera 54 and by a sonogram generated by the ultrasonic sensor 58.

If the medication dispensing device 20 is unable to determine the types and quantities of the pills 22a within the pod 30, then the agitator 62 may be activated to shake up the pills 22a in the pod 30 to improve their orientation prior to taking another image and sonogram with the camera 54 and ultrasonic sensor 58 respectively. These additional images can be used in the predictive model for training and validation operations. These additional images photographs, provide filed data of the pods 30 with a known quantity of pills 22a therein can further improve the artificial intelligence database. The dispensing device 20 can use its agitator 62 to change the position of the pills 22a and then take multiple images. A larger data set leads to better operation of the predictive models and may improve operation of all medication dispensing devices 20 collectively based on an improved predictive model.

In some embodiments, the medication dispensing device 20 may also include a data reader 63 (schematically illustrated in FIG. 11), which can be in the form of a label scanner (such as a bar code or QR code scanner) and/or a wireless tag reader (such as a radio frequency identification [RFID] scanner) to read data contained on a label or a chip on the pod. More specifically, when a pod 30 is filled in a pharmaceutical setting, a label or wireless tag containing data related to the contents of the pod 30 can be affixed to the pod 30. When the pod 30 is inserted into the tray, the scanner 63 in the medication dispensing device 20 can read this data and input it into the control circuitry or the controller of the dispensing device. The data on the label or wireless tag can also contain dosage instructions and any other information related to the pills contained within the pod.

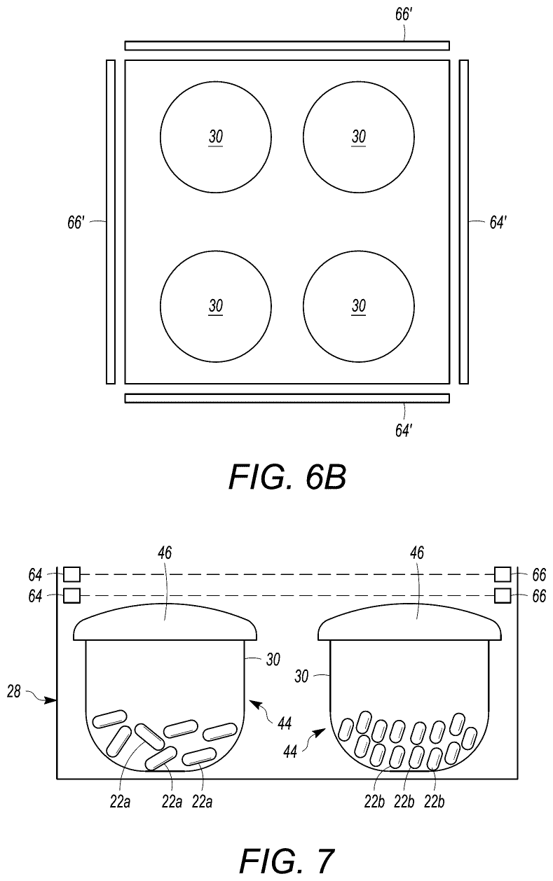

In the exemplary embodiment depicted in FIG. 6A, when the tray 28 is in the extended position illustrated in FIG. 2, the tray 28 may be configured to produce a light curtain above or partially through the pods 30 to detect the insertion or removal of any pills 22a-d into or from any of the pods 30. To produce this light curtain, the tray 28 includes side walls with a plurality of light emitters 64 (e.g., diodes) and a plurality of detectors or sensors 66. In an exemplary embodiment, the light emitters 64 direct light directly across the tray 28 to a plurality of light emitters 66 located on an opposite side of the tray 28. Some of the light emitters 64 project light orthogonally to other light emitters 64 such that the light curtain is two-dimensional. When an action is detected by the breaking of one or more beams of light, the medication dispensing device 20 is able to identify which of the pods 30 is being accessed based on which combination of the plurality of light detectors 66 detect a break in the beams of light being projected by their respective light emitters 64. In other words, since the plurality of light emitters 64 project light in two directions that are orthogonal to one another, the medication dispensing device 20 is able to determine with high accuracy the location of the break of the light curtain in two-dimensions, and thus, which pod 30 is being accessed. In an exemplary embodiment, the light emitted by the light emitters 64 is in the infra-red spectrum such that the light curtain is not visible to the human eye. In some other embodiments, the light can be in the visible spectrum.

When a break in the light curtain is detected, the medication dispensing device 20 is able to determine whether the event was adding or removing a pill 22a to/from a pod 30 by comparing a weight measurement prior to the event to a weight measurement after the event. If the weight measurement after the event is greater than the weight measurement before the event, then the medication dispensing device 20 can also determine how many pills 22a were added to the pod 30 based on the difference in the weight measurements and the known weight of each pill 22a of the type contained in the respective pod 30. Using a similar technique, the number of pills 22a removed from the pod 30 can also be determined if the weight measurement after the event is lower than the weight measurement before the event. If the medication dispensing device 20 determines that an incorrect number of pills 22a (either too many pills 22a or too few pills 22a) have been withdrawn from one of the pods 30 during a dispensing event, then the medication dispensing device 20 can alert the user through any of the aforementioned output means, such as the display screen 40 or the speaker 34, or through the user's external device 24.

In the embodiment of FIG. 6B, the light curtain is produced by a pair of wide emitters 64′ which project blankets of light over the top of the pods 30 and in the direction of respective sensors or detectors 66′. Using two such wide emitters 64′ that are orthogonal to one another, the medication dispensing device 20 is able to determine a location of any break in the light curtains to determine which specific pod 30 or pods 30 is/are being accessed by the user when the light curtain is broken.

As illustrated in FIG. 7, in an exemplary embodiment, the medication dispensing device 20 includes two vertically spaced apart light curtains that are independent of one another above the pods 30. In some embodiments, the lids 46 on the pods 30 are transparent such that the lids 46 themselves do not break either of the light curtains. In other embodiments, the lids 46 can break the light curtains themselves.

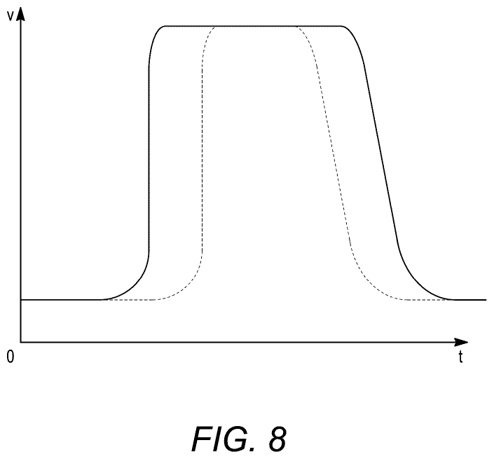

FIG. 8 depicts a pair of voltage waveforms, one for each of the light curtains, during a dispensing event. Specifically, the solid line in FIG. 8 illustrates a plot of the voltage generated by the upper light detector 66 as a user's hand reaches into a pod 30, grabs one or more pills 22a from the pod 30, and is removed from the pod 30 during a dispensing event. The dashed line illustrates a plot of the voltage generated by the lower light detector 66 during the same dispensing event. As can be seen, the upper and lower light detectors 66 produce similar voltage patterns, but the lower light detector's 66 voltage pattern is shorter than the upper light detector's 66 voltage pattern. Specifically, the voltage output of the lower light detector 66 spikes later than the upper light detector 66 and falls back to the baseline sooner than the upper light detector 66 because the lower light curtain is broken second and restored first.

The microprocessor 900 (shown in FIG. 11) of the control circuitry of the dispensing device 20 may be pre-programmed to recognize the certain voltage changes when one or both of the light curtains is broken as being associated with the different types of pills 22a-d. For example, in an embodiment, the microprocessor 900 may be configured to recognize a voltage change of 325±25 mV as being associated with one type of pill 22a and to recognize a voltage change of 250±25 mV as being associated with a different type of pill 22b. In other embodiments, the voltage change may be a negative value, i.e., the voltage at the light detector decreases when the one or both of the light curtains is broken. In either scenario where the voltage change is either positive or negative, the microprocessor 900 interprets such an event as a positive confirmation that a pill 22a-d has passed into or out of the associated pod 30 that is determined to have been opened and records the event into the memory 902 (see FIG. 11).

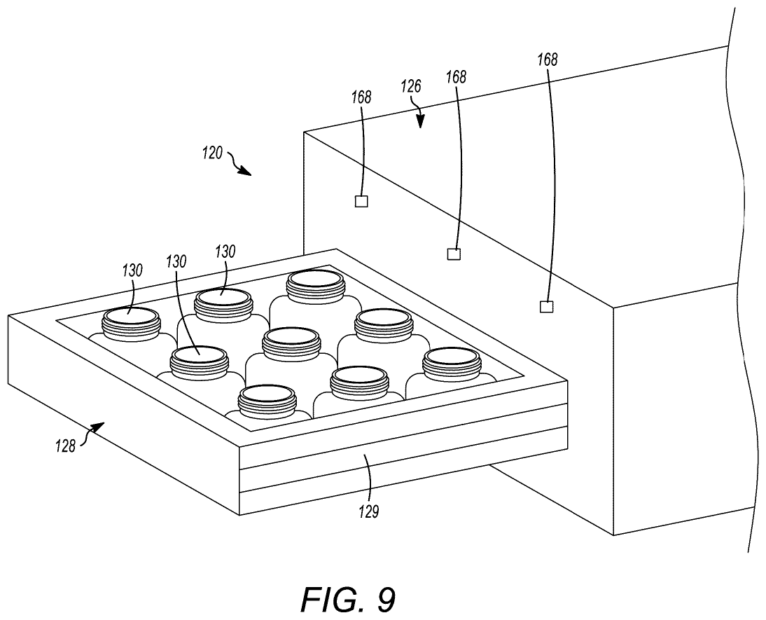

FIG. 9 depicts an alternate embodiment of the dispensing device 120 with like numerals, separated by a prefix of “1” identifying like components with the above-discussed embodiment. In this alternate embodiment, the housing 126 includes one or more cameras 168 that activate each time the tray 126 is extended to present the pods 130, which are in the form of bottles as discussed in further detail below, contained therein to the user. The cameras 168 can be spaced apart from one another and can take images of the pods 130 from different angles. Using artificial intelligence, the images taken by the cameras 168 can be analyzed to determine which pod 130 or pods 130 have been accessed by the user and which types and numbers of pills were removed from the pods 130.

Additionally, in the alternate embodiment depicted in FIG. 9, the pods 130 on the tray are bottles 130. In this embodiment, the bottles 130 are low profile with wide openings so that the pills sitting on the bottom of a bottle 130 can be accessed by the user with their fingers without tipping over the bottles 130. In this embodiment, the bottles 130 can be pre-filled in a pharmacy and inserted by the user into the tray 128 of the medication dispensing device 120. Also, in this embodiment, the tray 128 may be higher profile (have higher side walls) than the embodiment where the pills are contained in the relatively smaller pods described above.

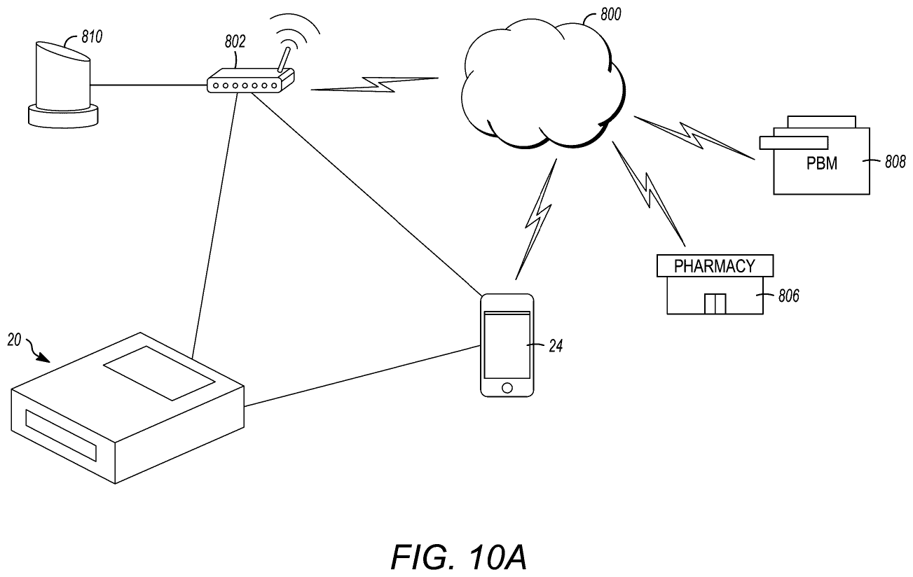

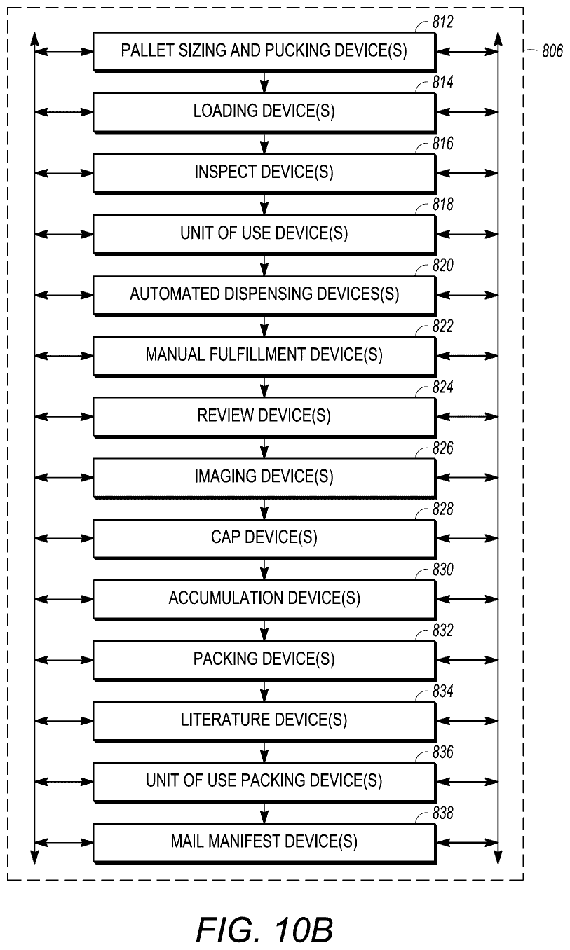

FIG. 10A is a schematic view showing an eco-system in which the medication dispensing device 20 can operate. The medication dispensing device 20 is electrically connected with the internet 800 via a portal, such as a router 802 (wired or wireless) or the external device 24 or through any suitable internet gateway. Through the internet 800, the dispensing device 20 is able to communicate with a pharmacy 806 and with a pharmacy benefit manager 808. Thus, the pharmacy 806 and pharmacy benefit manager 808 can monitor the dispensing of the pills out of the dispensing device 20 to monitor a user's compliance to his or her medication schedule. In some embodiments, the pharmacy 806 and/or the pharmacy benefit manager 808 can automatically order a new prescription in response to the quantity of that medication in the dispensing device 20 falling below a predetermined threshold. The dispensing device 20 can also communicate with the external device 24 or with a voice assistant 810 (such as those sold by Google®, Amazon®, and Apple®) directly and/or via the router 802.

The medication dispensing device 20 may use its communication functions, e.g., audio, VOIP or text, to call a pharmacist device. When this communication is established the dispensing device may encrypt the communication to ensure private communication. Such a communication can address medication concerns or questions. The communication functions can include the display, the microphone and the speaker built into the dispensing device, each of which can be controlled by control circuitry and use transmission circuitry to communicate with remote devices. In an example embodiment, the dispensing device may use its display to show video of the pharmacist (or nurse) speaking in real-time for a more personal interaction with the patient.

Additional devices may communicate with other devices parties in the communication system. The additional devices can be a payer device or a prescriber device. The payer device can be part of an adjudication system or an insurance company system. The prescriber device may be part of a medical care facility or individual medical care provider computing system or may be the prescriber of the medication and the payer (such as insurance company). These additional devices may be directly connected or indirectly connected in which case the PBM or pharmacy could be an intermediary to the payer or prescriber devices.

For example, the user of the dispensing device 20 may interact with the external device 24 to provide various voice commands. The voice commands may indicate the user's desire to refill a prescription, dispense daily or periodic medications, or other suitable voice commands. The external device 24 may communicate with the dispensing device 20 to provide data corresponding to the voice commands. The dispensing device 20 may take action in response to receiving the data from the external device 24. For example, the dispensing device 20 may communicate with the pharmacy 806 to refill a prescription based on the data received from the external device 24. It should be understood that the dispensing device 20 may receive any suitable data from the external device 24 and may take any suitable action in response to the data.

In some embodiments, the dispensing device 20 may include an input device configured to receive audible signals. The input device may include a microphone or other audio input device. The audible signals may include voice commands from the user (e.g., or caretaker and the like), an audible indication from a mobile computing device (e.g., a wearable device, a smart phone, and the like), any other suitable audible signal, or a combination thereof. For example, the user may provide voice commands directly to the dispensing device 20 using the microphone 34. In some embodiments, the input device may be configured to communicate with a brain wave scanning device that can process the user's brain pattern activities such that the user can provide a demand for a pill to the dispensing device 20 without any physical or audible action.

Additionally, or alternatively, the dispensing device 20 and/or a mobile computing device that communicates with the dispensing device 20 can provide reminders to the user to take medications according to a medication schedule that is either stored in the memory of the dispensing device 20 or remotely therefrom. The mobile computing device or the dispensing device 20 may generate an audible signal at a predetermined time (e.g., corresponding to a reminder to take a particular mediation). The dispensing device 20 may dispense medication corresponding to the audible signal. The mobile computing device may run according to instructions stored therein to operate and may contain an application that communicates with the dispensing device 20, e.g., so if the user dismisses a reminder on either the dispensing device 20 or the mobile computing device, the alert also stops on the other. The medication regimen reminders can also be output by the external device 24 based on the dosage schedule information that the device knows from scanning the bottle label, written prescription from the pharmacy, etc. The user of the medication dispensing device 20 can opt-in to receiving notifications or reminders that are generated by the medication dispensing device 20 and communicated to the external device 24 associated with the user. In an example embodiment, the user's external device 24 is authorized by interaction with the PBM or insurance computing system, which can authorize use of the medication dispensing device 20 and gathering information from the medication dispensing device 20. The alerts can also include feedback about missed doses. The alerts and/or reminders may be animated or include a jingle or otherwise provide positive feedback to provide positive reinforcement to the user. In some embodiments, a reward system may be tied to medication adherence.

FIG. 10B generally illustrates the pharmacy 806 according to the principles of an embodiment of the present disclosure. The pharmacy 806 may be used to process and fulfill prescriptions and prescription orders, including pods or bottles for the medication dispensing device. After fulfillment, the fulfilled prescriptions are packed for shipping. The medication dispensing device 20 may be used with other pharmacy systems and the like.

The pharmacy 806 may include devices in communication with the pharmacy benefit manager 808, an order processing device, and/or the storage device, directly or over the network. Specifically, the pharmacy 806 may include pallet sizing and pucking device(s) 812, loading device(s) 814, inspect device(s) 816, unit of use device(s) 818, automated dispensing device(s) 820, manual fulfillment device(s) 822 (which may be fulfill environmentally controlled drugs), review devices 824, imaging device(s) 826, cap device(s) 828, accumulation devices 830, packing device(s) 832, literature device(s) 834, unit of use packing device(s) 836 (which may be pack environmentally controlled drugs), and mail manifest device(s) 838. Further, the pharmacy 806 may include additional devices, which may communicate with each other directly or over the network.

In some embodiments, operations performed by one of these devices 812-838 may be performed sequentially, or in parallel with the operations of another device as may be coordinated by the order processing device, which may include a dedicated processor in operable communication with a memory. In some embodiments, the order-processing device tracks a prescription with the pharmacy based on operations performed by one or more of the devices 812-838.

In some embodiments, the pharmacy may transport prescription drug containers, for example, among the devices 812-838 in the high-volume fulfillment center, by use of pallets. The pallet sizing and pucking device 812 may configure pucks in a pallet. A pallet may be a transport structure for a number of prescription containers, such as bottles or pods that can be inserted into the medication dispensing device and may include a number of cavities. A puck may be placed in one or more than one of the cavities in a pallet by the pallet sizing and pucking device 812. The puck may include a receptacle sized and shaped to receive a prescription container. Such containers may be supported by the pucks during carriage in the pallet. Different pucks may have differently sized and shaped receptacles to accommodate containers of differing sizes, as may be appropriate for different prescriptions.

The arrangement of pucks in a pallet may be determined by the order processing device based on prescriptions that the order processing device decides to launch. The arrangement logic may be implemented directly in the pallet sizing and pucking device 812. Once a prescription is set to be launched, a puck suitable for the appropriate size of container for that prescription may be positioned in a pallet by a robotic arm or pickers. The pallet sizing and pucking device 812 may launch a pallet once pucks have been configured in the pallet.

The loading device 814 may load prescription containers into the pucks on a pallet by a robotic arm, a pick and place mechanism (also referred to as pickers), etc. In various embodiments, the loading device 814 has robotic arms or pickers to grasp a prescription container and move it to and from a pallet or a puck. The loading device 814 may also print a label that is appropriate for a container that is to be loaded onto the pallet, and apply the label to the container. The pallet may be located on a conveyor assembly during these operations (e.g., at the high-volume fulfillment center, etc.).

The inspect device 816 may verify that containers in a pallet are correctly labeled and in the correct spot on the pallet. The inspect device 816 may scan the label on one or more containers on the pallet. Labels of containers may be scanned or imaged in full or in part by the inspect device 816. Such imaging may occur after the container has been lifted out of corresponding puck by a robotic arm, picker, etc., or may be otherwise scanned or imaged while retained in the puck. In some embodiments, images and/or video captured by the cameras within the medication dispensing device 20 may be stored in the storage device as order data.

The unit of use device 818 may temporarily store, monitor, label, and/or dispense unit of use products. In general, unit of use products are prescription drug products that may be delivered to a user or member without being repackaged at the pharmacy 806. These products may include pills in a container, pills in a blister pack, inhalers, temperature-controlled drugs, etc. Prescription drug products dispensed by the unit of use device 818 may be packaged individually or collectively for shipping, or may be shipped in combination with other prescription drugs dispensed by other devices in the high-volume fulfillment center.

At least some of the operations of the devices 812-838 may be directed by the order processing device. For example, the manual fulfillment device 822, the review device 824, the automated dispensing device 820, and/or the packing device 832, etc. may receive instructions provided by the order processing device.

The automated dispensing device 820 may include one or more devices that dispense prescription drugs or pharmaceuticals into prescription containers in accordance with one or multiple prescription orders. In general, the automated dispensing device 820 may include mechanical and electronic components with, in some embodiments, software and/or logic to facilitate pharmaceutical dispensing that would otherwise be performed in a manual fashion by a pharmacist and/or pharmacist technician. For example, the automated dispensing device 820 may include high-volume fillers that fill a number of prescription drug types at a rapid rate and blister pack machines that dispense and pack drugs into a blister pack. Prescription drugs dispensed by the automated dispensing devices 820 may be packaged individually or collectively for shipping, or may be shipped in combination with other prescription drugs dispensed by other devices in the high-volume fulfillment center.

The manual fulfillment device 822 controls how prescriptions are manually fulfilled. For example, the manual fulfillment device 822 may receive or obtain a container and enable fulfillment of the container by a pharmacist or pharmacy technician. In some embodiments, the manual fulfillment device 822 provides the filled container to another device in the pharmacy fulfillment devices to be joined with other containers in a prescription order for a user or member. For example, non-environmentally controlled drugs and environmentally controlled drugs may be filled and joined together for packaging.

In general, manual fulfillment may include operations at least partially performed by a pharmacist or a pharmacy technician. For example, a person may retrieve a supply of the prescribed drug, may make an observation, may count out a prescribed quantity of drugs and place them into a prescription container, etc. or retrieve drugs from a cooler. Some portions of the manual fulfillment process may be automated by use of a machine. For example, counting of capsules, tablets, or pills may be at least partially automated (such as through use of a pill counter). Prescription drugs dispensed by the manual fulfillment device 822 may be packaged individually or collectively for shipping, or may be shipped in combination with other prescription drugs dispensed by other devices in the high-volume fulfillment center.

The review device 824 may process prescription containers to be reviewed by a pharmacist for proper pill count, exception handling, prescription verification, etc. Fulfilled prescriptions may be manually reviewed and/or verified by a pharmacist, as may be required by state or local law. A pharmacist or other licensed pharmacy person who may dispense certain drugs in compliance with local and/or other laws may operate the review device 824 and visually inspect a prescription container that has been filled with a prescription drug. The pharmacist may review, verify, and/or evaluate drug quantity, drug strength, and/or drug interaction concerns, or otherwise perform pharmacist services. The pharmacist may also handle containers which have been flagged as an exception, such as containers with unreadable labels, containers for which the associated prescription order has been canceled, containers with defects, etc. In an example, the manual review may be performed at a manual review station.

The imaging device 826 may image containers once they have been filled with pharmaceuticals. The imaging device 826 may measure a fill height of the pharmaceuticals in the container based on the obtained image to determine if the container is filled to the correct height given the type of pharmaceutical and the number of pills in the prescription. Images of the pills in the container may also be obtained to detect the size of the pills themselves and markings thereon. A temperature-controlled package may be imaged to ensure the correct coolant is in the package. The images may be transmitted to the order processing device and/or stored in the storage device as part of the order data.

The cap device 828 may be used to cap or otherwise seal a prescription container. In some embodiments, the cap device 828 may secure a prescription container with a type of cap in accordance with a user preference (e.g., a preference regarding child resistance, etc.), a plan sponsor preference, a prescriber preference, etc. The cap device 828 may also etch a message into the cap, although this process may be performed by a subsequent device in the high-volume fulfillment center.

The accumulation device 830 accumulates various containers of prescription drugs in a prescription order. The accumulation device 830 may accumulate prescription containers from various devices or areas of the pharmacy. For example, the accumulation device 824 may accumulate prescription containers from the unit of use device 818, the automated dispensing device 820, the manual fulfillment device 822, and the review device 824. The accumulation device 830 may be used to group the prescription containers prior to shipment to the member.

The literature device 834 prints, or otherwise generates, literature to include with each prescription drug order. The literature may be printed on multiple sheets of substrates, such as paper, coated paper, printable polymers, or combinations of the above substrates. The literature printed by the literature device 834 may include information required to accompany the prescription drugs included in a prescription order, other information related to prescription drugs in the order, financial information associated with the order (for example, an invoice or an account statement), etc.

In some embodiments, the literature device 834 folds or otherwise prepares the literature for inclusion with a prescription drug order (e.g., in a shipping container). In other embodiments, the literature device 834 prints the literature and is separate from another device that prepares the printed literature for inclusion with a prescription order.

The packing device 832 packages the prescription order in preparation for shipping the order. The packing device 832 may box, bag, or otherwise package the fulfilled prescription order for delivery, which can include pods filled with medications. The packing device 832 may further place inserts (e.g., literature or other papers, etc.) into the packaging received from the literature device 834. For example, bulk prescription orders may be shipped in a box, while other prescription orders may be shipped in a bag, which may be a wrap seal bag.

The packing device 832 may label the box or bag with an address and a recipient's name. The label may be printed and affixed to the bag or box, be printed directly onto the bag or box, or otherwise associated with the bag or box. The packing device 832 may sort the box or bag for mailing in an efficient manner (e.g., sort by delivery address, etc.). The packing device 832 may include ice or temperature sensitive elements for prescriptions that are to be kept within a temperature range during shipping (for example, this may be necessary in order to retain efficacy). The ultimate package may then be shipped through postal mail, through a mail order delivery service that ships via ground and/or air (e.g., UPS, FEDEX, or DHL, etc.), through a delivery service, through a locker box at a shipping site (e.g., AMAZON locker or a PO Box, etc.), or otherwise to a delivery location. Some packages will be delivered using autonomous delivery vehicles, e.g., ground vehicles or aircraft, to the delivery location.

The unit of use packing device 836 packages a unit of use prescription order in preparation for shipping the order. The unit of use packing device 836 may include manual scanning of containers to be bagged for shipping to verify each container in the order. In an example implementation, the manual scanning may be performed at a manual scanning station. A mail manifest device 838 may print mailing labels used by the packing device 832 and may print shipping manifests and packing lists.

Multiple devices may share processing and/or memory resources. The devices 812-838 may be located in the same area or in different locations. For example, the devices 812-838 may be located in a building or set of adjoining buildings. The devices 812-838 may be interconnected (such as by conveyors), networked, and/or otherwise in contact with one another or integrated with one another (e.g., at the high-volume fulfillment center, etc.). In addition, the functionality of a device may be split among a number of discrete devices and/or combined with other devices.

Referring back to FIG. 10A, the PBM device 808 or the payor device can operate a predictive model to improve adherence of an individual user of the medication dispensing device 20 based on data from a group of dispensing devices out in the field combined with data generated in the lab controlled by the payor or the PBM 808. The sensors in the medication dispensing device 20 can feed data back to a database. This data can train or validate a predictive model, which can be generated using machine learning. The predictive model can operate to predict and to validate the contents and count of items in the containers. All of the dispensing devices (i.e., both the one owned by the user and other users) can provide feedback to further refine the predictive model. The predictive model can also operate on a medication type to determine if there are more adherence issues based on type of drug in conjunction with or separate from the type of user of the dispensing device. The ability of dispensing device 20 to reproduce the exact conditions in the prediction environment (local) as were used in the training environment (remote), such as lighting and bottle positioning, will improve the accuracy of predictions in the predictive model.

The medication dispensing device 20 may be configured to communicate directly with medical care providers (such as a doctor, a nurse, or a pharmacist) and/or allow the user to communicate with a medical care provider directly. The direct communication between the user and the medical care provider may be a telehealth appointment with audio and/or video displayed on the touch screen. This may allow the user to order and/or process a refill of a medication or order a new medication to be inserted into the dispensing device. The dispensing device 20 may automatically schedule such a telehealth appointment based on any suitable factor, e.g., when the quantity of a medication in the dispensing device falls below a threshold. During the telehealth appointment, the dispensing device 20 can provide data to the medical care provider. The data can include data from the user's wearable device(s), such as a smart watch or a glucose monitor, and/or information about any recently missed doses of medication. For example, the dispensing device 20 uses its agitation functionality to agitate the contents in a pod 30 in addition to taking multiple reads for prediction provides a low-cost method at model training time to automate the obtaining of multiple images (as many as needed by the training algorithm) with pills/contents rearranged after each agitation, to train predictive models.

In FIG. 11, the electrical or computing system of the medication dispensing device 20 is schematically illustrated. As shown, the dispensing device 20 includes a microprocessor 900, which may be referred to herein as the processor 900, that is in electrical communication with a memory 902 so that the processor 900 can read from and write to the memory 902. The processor 900 may include any suitable processor, such as those described herein. Additionally, or alternatively, the dispensing device 20 may include any suitable number of processors in addition to the processor 900. The memory 902 may comprise a single disk or a plurality of disks (e.g., hard drives), and includes a storage management module that manages one or more partitions within the memory 902. In some embodiments, memory 902 may include flash memory, semiconductor (solid state) memory or the like. The memory 902 may include Random Access Memory (RAM), a Read-Only Memory (ROM), or a combination thereof. The memory 902 is preferably of the non-volatile type such that the data stored thereon is not lost in the event of a power failure in the dispensing device 20. The memory 902 may include instructions that, when executed by the processor 900, cause the processor 900 to, at least, control various aspects the dispensing device 20.

The memory 902 contains data which includes: (1) which medications are contained in the dispensing device 20, e.g., in the pods 30 on the tray 28; (2) the medication counts for each of these medications; (3) an automatic dispensing schedule (which can be adjusted by the user, the pharmacy 806, or the pharmacy benefit manager 808); (4) a log containing time stamps of all dispensing and filling events; (5) an updateable database of predictive models to be accessed when confirming the contents of a the pods 30; and (6) additional health data related to the user (for example, data uploaded to the dispensing device 20 from a wearable device 911, such as a smart watch or a glucose monitor). The dispensing device 20 is preferably powered by alternating current (AC) from a wall outlet as its primary power source but contains a battery backup so that operation continues in the event of a loss of power from the primary power source. The dispensing device 20 further includes a wireless module 904, which allows the dispensing device 20 to connect with the internet router 802 and/or external device 24.

The predictive models can be built and maintained outside of the dispensing device 20, e.g., in pharmacy systems or medical systems, and can be refreshed periodically using stored data. The dispensing device 20 includes an inspection zone to produce inputs to the prediction model. The inputs can include a label image, at least one bar codes, scan codes, multiple photo and sonographic images of contents, and net weight.

The dispensing device 20 is also preferably provided with a security system, which must be cleared prior to unlocking one or more of the pods 24 on the tray 28. The security system relies on a positive identification of the user through one or more of a personal identification number (PIN), thumbprint, facial recognition, a mobile phone app, a card reader, a Universal Serial Bus (USB) token, a Rivest-Shamir-Adleman (RSA) token, etc. The security system can also utilize on one or more sensors in a user's mobile device, such as the external device 24, to establish the positive identification. That is, before a medication is dispensed, the dispensing device 20 can communicate with the external device 24 which, in turn, will require the user to verify the user's identity through, for example, a fingerprint sensor or a facial identification sensor built into the external device 24.

In some embodiments, the medication dispensing device 20 may include one or more sensors configured to measure or sense various aspects of the dispensing device 20 and/or an environment external to the medication dispensing device 20 to wake the device 20 from a low power or “sleep” mode. For example, the dispensing device 20, may include a motion sensor, or other suitable sensor, configured to detect motion proximate to the dispensing device 20. The sensor could be, for example, the microphone 34 and/or the camera 42. The processor 900 may receive data from the sensor and may illuminate the display screen 40 in response to the detected motion.

In some embodiments, the medication dispensing device 20 may include one or more vital measurement devices. For example, the dispensing device 20 may include a pulse monitor, a blood pressure cuff (e.g., of other suitable blood pressure measuring device), a thermometer 43 (e.g. a touchless thermometer or other suitable thermometer), other suitable vital measurement devices, or a combination thereof. The user may interact with the one or more vital measurement devices. For example, the user may use a pulse monitor to measure the user's pulse. The processor 900 may receive a pulse measurement from the pulse monitor indicating the user's pulse. The processor 900 may store the pulse measurement in user measurements table or database (herein after referred to as the user measurement data). The user measurements data may be stored on the memory 902, on a cloud computing device, on a mobile computing device of the user, or other suitable location. For example, the processor 900 may store and/or update the user measurements data in the memory 902. Additionally, or alternatively, the processor 900 may communicate with a suitable cloud computing device, remotely located server, mobile computing device, or other suitable remotely located computing device to store and/or update the user measurements data.

In some embodiments, the user may interact with a blood pressure measuring device of the dispensing device 20. The user may use the blood pressure measuring device to measure a blood pressure of the user. The processor 900 may receive a blood pressure measurement from the blood pressure measuring device indicating the blood pressure of the user. The processor 900 may update the user measurements data to include the blood pressure measurement.

In some embodiments, the user may interact with a thermometer 43 of the medication dispensing device 20. The user may use the thermometer 43 to measure a temperature of the user. The processor 900 may receive a temperature measurement from the thermometer indicating the user's temperature. The processor 900 may update the user measurement data to include the temperature measurement. It should be understood that the dispensing device 20 may include any suitable measuring device that the user may interact with to provide measurement data corresponding to the user.

In some embodiments, the user may interact with a keyboard, the touch screen 40, or other suitable input device to provide various measurements (e.g., pulse measurement, blood pressure measurement, temperature measurement, insulin measurement, other suitable measurements, or a combination thereof). For example, the user may interact with the touch screen 40 on the dispensing device 20 to provide various measurements to the dispensing device 20. In some embodiments, the user may interact with an application on the external device 24. The user may provide user measurement data using the application. The application may communicate the user measurement data, using the external device 24, to the dispensing device 20. The processor 900 may store and/or update the user measurement data, based on the received various measurements.

In some embodiments, the processor 900 may be configured to communicate the user measurement data to a pharmacist and/or medical provider. The pharmacists and/or medical provider may review the user measurement data and determine whether to adjust one or more medication doses taken by the user. The pharmacist and/or medical provider may, using a suitable computing device, communicate an adjusted medication dose to the dispensing device 20. The dispensing device 20 may adjust a dispensing amount for the medication based on the adjusted dose for the medication.

In some embodiments, the dispensing device 20 may be configured to communicate with other devices on the same network or within a range of the dispensing device 20. As described, the dispensing device 20 may include the wireless module 904. The wireless module 904 may include any suitable wireless communications device include a wireless fidelity (WiFI) communications device, a Bluetooth device, a near field communications device, any other suitable wireless communications device, or a combination thereof. The wireless module 904 may communicate with a network, such as a Local Area Network, a Wide Area Network, the Internet, and/or other suitable networks. The wireless module 904 may communicate with the network via the router 802.

In some embodiments, the processor 900, using the wireless module 904, may identify other devices on the network. For example, the processor 900 may identify devices on the network operating according to the same communications protocol. The other device may include Internet of Things (IOT) enabled devices, such as a coffee maker, a refrigerator, a smart switch, a smart light, an alarm clock, other suitable devices, or a combination thereof. The processor 900 may identify behavioral patterns of the user based on communications with the other devices on the network. For example, the user may start a coffee maker, open a refrigerator, turn on one or more lights, turn off an alarm clock, and the like.

The processor 900 may adjust a dispensing schedule of medications in the dispensing device 20 based on an identified behavioral pattern. For example, the dispensing device 20 may open the tray 28 and unlock one or more of the pods 30 at a time that corresponds to the user being within a range of the dispensing device 20. The processor 900 may identify the time that corresponds to the using being within the range of the dispensing device 20 based on the identified behavioral pattern.

In some embodiments, the processor 900 may determine whether various medications dispensed by the dispensing device 20 and consumed by the user have adverse effects on the user. For example, the processor 900 identify a sudden change in the behavioral pattern of the user and determine that one or more medications may be contributing to the change in behavioral patterns. For example, the processor 900 may be in communication with a machine learning mechanism configured to identify behavioral changes corresponding to potential side effects of certain medications. The processor 900 may generate an indication (e.g. such as a message or other suitable indication) indicating that the user may be experience side effects from one or more medications. The processor 900 may communicate, using the router 802, the indication to pharmacist and/or medical provider. The pharmacist and/or medical provider may contact the user and/or may adjust one or more doses of medications being consumed by the user.

In some embodiments, the dispensing device 20 may allow the user to withdraw a multiple day supply of medications in response to a request by the user. For example, the user may provide an input to the dispensing device 20 using any suitable input. For example, the demand may be input to the dispensing device 20 by a physical interaction by the user with the touch screen 40, by an interaction between the user and the external device 24, by an audible demand by the user that is sensed by the microphone 34 of the dispensing device 20, or by a user's thought that is captured by a device implanted in or otherwise in communication with the user's brain.

The user may also demand a quantity of pills for a time period that the user will be away from the medication dispensing device 20, e.g., before the user goes on vacation, on a work trip, in the hospital, or any other suitable reason. For example, the user may be taking a trip and will not be near the dispensing device 20 for the period. The user may provide the dispensing device 20 with a number of days that the user will be away from the dispensing device 20. The processor 900 may determine a quantity of each of the various medications taken by the user for the number of days and instruct the user on how many pills 22a-d to remove from each of the pods 30.

In some embodiments, the processor 900 may dispense a single day supply of medication into one or more plastic pouches. In some embodiment, the processor 900 may communicate with a pharmacist and/or medical provider indicating that the user has requested the multiple day supply of medication. The pharmacist and/or medical provider may determine whether to allow the dispensing device 20 to dispense the multiple day supply. The processor 900 may receive an indication from the pharmacists and/or medical providing instructing the dispensing device 20 to dispense the multiple day supply. In response to the processor 900 receiving instructions from the pharmacist and/or medical provider indicating not to dispense the multiple day supply, the processor 900 may provide to the user (e.g., via the touch screen, communication via the mobile device, or any suitable mechanism), indicating to the user to contact the pharmacist and/or medical provider.

In some embodiments, the processor 900 may be configured to communicate with a calendaring application associated with the user. For example, the user may utilize a calendaring application on the mobile device or any suitable computing device. The processor 900 may identify travel plans stored in the calendaring application indicating that the user may be away from the dispensing device 20 for a period. The processor 900 may generate a request to a pharmacist and/or medical provider indicating that the user may be away from the dispensing device 20. The request may request that the pharmacist and/or medical provider contact the user. In some embodiments, the processor 900 may dispense a multiple day supply in response to identifying travel plans in the user's calendaring application.

In some embodiments, the processor 900 may identify scheduled events in the calendaring application. For example, the processor 900 may identify scheduled events that begin prior to a normal dispensing time. The processor 900 may determine to dispense the mediations prior to the identified scheduled event (e.g. such that the user does not leave the proximity of the dispensing device 20 prior to the mediations being dispensed).

In some embodiments, the processor 900 may be configured to verify the identity of the user. The processor 900 may be configured to receive various biometric data of the user, such as a facial scan, a retina scan, a fingerprint scan, and the like. For example, the processor 900 may receive or retrieve a file that contains the facial recognition data and compare it to the image data captured by an image capturing device. The image capturing device may be the camera 42 that is disposed on the top of the dispensing device 20, a camera associated with the external device 24, or any other suitable image capturing device. The processor 900 may compare the facial recognition data with the image data using facial recognition software. The processor 900 may verify the user's identify in response to a determination that the facial recognition data matches the image data.

In some embodiments, the processor 900 compares the audible input to a corresponding stored file (e.g., a similar audible input, such as a sample of the speech of the user, a corresponding tone, or other suitable audible data or other suitable data). The processor 900 may verify the identity of the user based on a determination that the audible input matches the corresponding file.

In some embodiments, the processor 900 may receive one or more fingerprints scans of the user using the fingerprint scanner 38. The processor 900 may verify the identity of the user by comparing the fingerprint scans with stored fingerprints associated with the user. In some embodiments, the processor 900 may scan one or more retinas of the recipient. For example, the processor 900 may receive one or more retina scans from a retina scanner disposed on the dispensing device 20, a retina scanner associated with the external device 24, or any other suitable retina scanner or retina scanning device. The processor 900 may compare the one or more retina scans with stored retina scans corresponding to the user. The processor 900 may verify the identity of the user in response to a determination that the received retina scans match the stored retina scans corresponding to the user.

In some embodiments, the dispensing device 20 may be configured to scan a quick response (QR) code or barcode of the associated with the user. For example, the user may receive a QR code or a barcode from the pharmacy application, an SMS message, a text message, an email, a phone call, or other suitable QR code source. The user may print the QR code or barcode or the user may present the QR code or the barcode on the external device 24.

The processor 900 may scan, using the camera 42, the QR code or the barcode on a pod 30 that is inserted into an opening of the tray. The processor 900 may compare the scanned QR code and/or barcode to a known QR code and/or barcode stored on the memory 902 or other suitable location. The QR code and/or barcode stored on the memory 902 or other suitable location may be generated by the processor 900. For example, the processor 900 may generate the QR code and/or barcode stored on the memory 902 or other suitable location and the QR code and/or barcode received by the user. In some embodiments, the processor 900 may receive the QR code and/or barcode from the pharmacy application. The processor 900 may verify the identify of the user in response to the QR code and/or barcode presented by the user matching the QR code and/or barcode stored on the memory 902 or other suitable location.

In some embodiments, the processor 900 may receive a numeric value from the user (e.g., via a keypad input, a touch screen, or other suitable input device, such as those described herein). For example, the user may receive a numeric value from the via the pharmacy application. The user may provide or input the numeric value to the dispensing device 20. The processor 900 may verify the identity of the user based on a comparison of the numeric value to a numeric value communicated to the processor 900 by via the pharmacy application. It should be understood that the processor 900 may receive any other suitable information from the user in addition to or instead of those described herein that the processor 900 may user to verify the identity of the user.

In some embodiments, the processor 900 may be configured to perform the methods described herein. In some embodiments, the processor 900 may communicate with various other devices, such as mobile computing devices, networks, cloud computing devices, remotely located servers, and the like to perform the methods described herein.

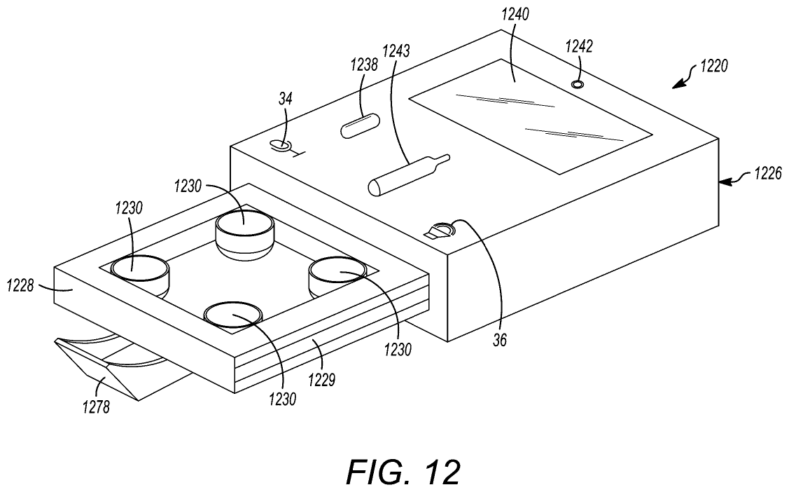

Turning now to FIGS. 12-15, an alternate embodiment of the medication dispensing device 1220 is illustrated with like numerals, separated by a prefix of “12,” identifying like components with the above-discussed embodiments. In this embodiment, the pods 1230 of the medication dispensing device 1220 are configured to singulate and dispense the pills 1222a, 1222b out of their respective interiors through their bottoms in addition to through their tops. As discussed in further detail below, this dispensing operation occurs in response to the application of a downward pressing force on the top of a pod 1230, which causes a normally closed dispensing orifice to open and dispense a pill. In an example the normally close opening is at least one slit 1270 in the bottom of the pod 1230 to elastically deform and open up a passage therethrough. In some embodiments, the downward pressing force can be applied by the user manually, i.e., the user pushing on the top of the pod 1230 with their finger. In some other embodiments, the downward force can be applied automatically by a plunger (which moves under power from a prime mover, e.g., an electric motor, linear actuator, or the like) that is located within the medication dispensing device. In another example, the force applied to the pod 1230 for dispensing includes a side force applied at least partly non-vertically onto the pod. The sideward force can be along the equatorial circumference or above the equatorial circumference of the pod, e.g., above the bottom half of the pod or above the slit(s) in the bottom of the pod.

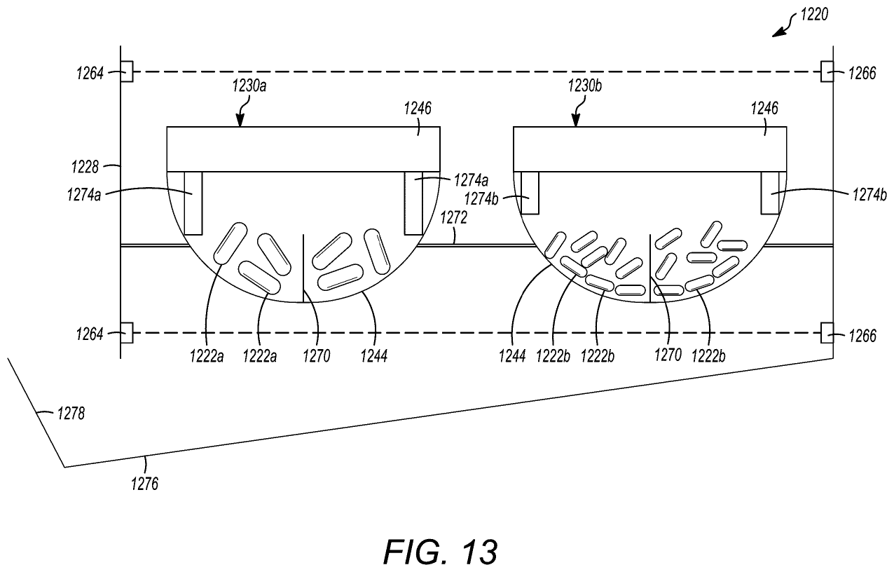

As illustrated in FIG. 13, in this embodiment, the tray 1228 lacks a floor but rather includes a platform 1272 that is located in a generally central area of the tray 1228 in the vertical direction. The platform 1272 includes a plurality of openings that receive and support side walls of the pods 1230 within the tray 1228 such that bottom areas of the pods 1230 protrude vertically below the platform 1272. In some embodiments, the platform 1272 can lockingly engage the pods 1230 to hold the pods 1230 in the tray 1228.

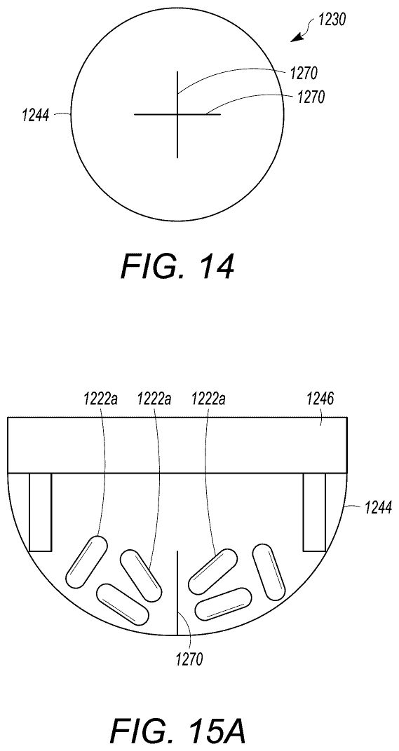

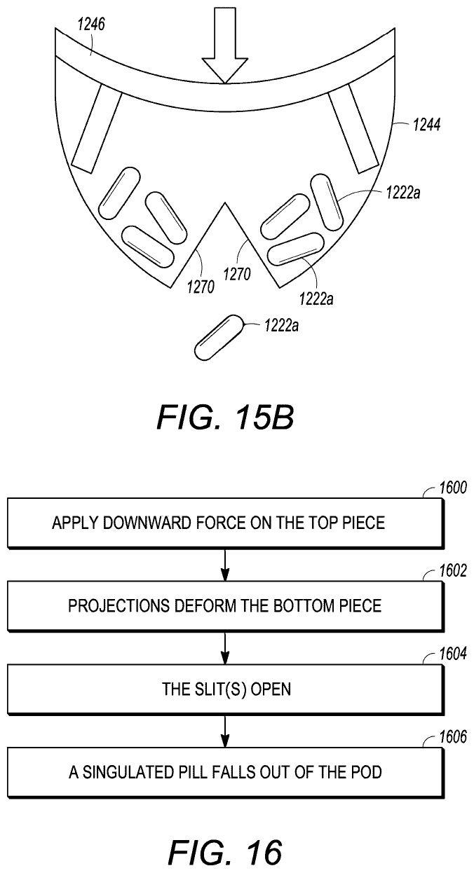

Turning now to FIGS. 14, 15A, and 15B, in this embodiment, the pods 1230 are made as at least two pieces, namely a cup-shaped bottom piece 1244 (receptacle piece) and a top piece 1246 (lid), that together define the pill containing interior. The bottom piece 1244 and the top piece 1246 are both made of elastomeric materials, which could be the same elastomeric material or different elastomeric materials (for example, natural or synthetic rubber materials), so that they can resiliently and elastically deform during a dispensing operation. A bottom region of the bottom piece 1244 includes a pair of slits 1250 or cuts that extend through a full thickness of the bottom piece 1270 and that can open up during a dispensing process to reveal the passage. More specifically, when the bottom piece 1244 is in a resting condition (FIG. 15A—without the application of a force on the top piece 1246), the slits 1270 are closed so that the pills 1222a cannot escape the interior of the pod 1230. In the exemplary embodiment, the slits 1270 extend perpendicular to one another to form a “plus” shape. More specifically, the slits 1270 intersect one another at a central location of the bottom piece 1244, and the slits 1270 extend outwardly from the intersection towards and partially onto a side wall of the pod 1230. In some embodiments, the bottom piece can have three or more slits that can open together and that can be arranged in different orientations relative to one another so long as they intersect one another.

When the top piece 1246 is in a resting condition (illustrated in FIG. 15A), it is generally planer or “hockey puck” shaped. A plurality of protrusions or projections 1274 extend downwardly from a lower surface of the top piece 1246 and into the pill containing interior to contact with a side wall of the bottom piece 1244. The projections 1274 can extend either directly in the vertical direction or can be angled relative to the vertical direction when the top piece 1246 is in the resting condition.

As illustrated in FIG. 15B, when a pressing force (for example, from the user's finger or by a device) is applied to the top piece 1246 (or above the bottom), the projections 1274 press against the sidewall of the bottom piece 1244. More specifically, the pressing force causes the top piece 1246 to deform elastically into a concave shape, thereby urging the ends of the projections 1274 outwardly and elastically deforming the bottom piece 1244 in such a way that the slits 1270 open to present the passage. Under the influence of gravity, a pill 1222a falls downwardly out of the pod 1230 through the passage. In the exemplary embodiment, the top piece 1246 includes four projections 1274 that contact the side wall of the bottom piece 1244 in locations that are spaced from the slits 1270, i.e., the projections 1254 do not contact the slits 1270.

The lengths and angles of the projections 1274 can dictate the amount that the slits 1270 open up, and thus, the size of a passage that is revealed when the downward pressing force is applied to the top piece 1246. Accordingly, the lengths of the projections 1274 can be specifically chosen to open the passage by a predetermined amount that is optimized for dispensing the pills 1222a, 1222b in the pod 1230 in a singulated fashion (one pill 1222a, 1222b per press on the top piece 1246). As illustrated in FIG. 13, a first pod 1230a in the tray 1228 includes projections 1274a that have a first length for opening the passage greatly when the top piece 1246 is pressed so that the relatively larger pills 1222a in the first pod 1230a can be dispensed in the singulated fashion. The second pod 1230b in the tray 1228 includes projections 1274b with a second length that is less than the first length so that when the top piece 1246 of the second pod 1230b is pressed, the passage opens by a lesser amount than the first pod 1230a to dispense the relatively smaller pills 1222b in the second pod 1230b in the singulated fashion.

When a pod 1230 is filled (e.g., by the user or a pharmacist), a top piece 1246 with the appropriate projections 1254 for dispensing the pills 1222 contained in the pod 1230 in the singulated fashion. In some embodiments, the projections 1254 can be monolithic with the remainder of the top piece 1246. This allows the same bottom piece 1244 to be usable with a wide range of different types of pills 1222, thereby allowing for cost savings through economies of scale. In some other embodiments, the projections can be made as separate elements with the remainder of the top piece and can be attached with the remainder of the top piece.

Turning now to FIG. 13, the tray 1228 includes a chute 1256 or trough that is located below all of the pods 1230a, 1230b and is angled to guide the pills 1222a, 1222b that are dispensed from the pods 1230a, 1230b towards a common opening 1258. When the pills 1222a, 1222b from any of the pods 1230a, 1230b in the tray 1228 are dispensed by pressing the top pieces 1246 of those pods 1230a, 1230b, the pills 1222a, 1222b fall onto the chute 1256 and are channeled by the chute 1256 to the opening 1258 for the user to more easily retrieve them. In some embodiments, the tray can lack a chute and the pills dispensed from the pods can fall directly onto a surface the medical dispensing device is located on, e.g., a counter or a table.

Referring still to FIG. 13, in this embodiment, the tray 1228 includes light emitters 1264 and detectors 1266 both above and below the pods 1230a, 1230b to create two light curtains, one at the top of the tray 1228 and the other at the bottom of the tray 1228. The detectors 1266 are configured to detect a location of a break in either of the light curtains. Accordingly, when either one or more pills 1222a, 1222b are added or removed to the pods 1230a, 1230b from above or when a pod 1230a, 1230b itself is removed from or inserted into the tray 1228 from above, this event is detected by the upper light detectors 1266 and recorded by the controller. Similarly, any time a pill 1222a, 1222b is dispensed from one of the pods 1230a, 1230b to the chute 1276, the dispensing event is captured by the lower light detectors 1266 when the pill 1222a, 1222b breaks the lower light curtain. The lower light detectors 1266 are even capable of detecting if multiple pills 1222a, 1222b were mistakenly dispensed from any of the pods 1230a, 1230b to alert the user of this occurrence.

Turning now to FIG. 16, a flow chart is presented that depicts the steps of dispensing a pill 1222 from a pod 1230 is depicted. At step 1600, a downward pressing force is applied by the user to the top piece 1246 to elastically deform the top piece 1246. At step 1602, the projections 1274 on the top piece 1246 press against the sidewall of the bottom piece 1244 to elastically deform the bottom piece 1244. At step 1604, the elastic deformation of the bottom piece 1244 causes the slits 1270 to open to present the passage. The projections 1254 are shaped such that the passage only opens by a predetermined amount necessary to allow just a single singulated pill to fit through the passage. At step 1606, a singulated pill 1606 falls out of the passage.

The present disclosure uses the term “singulated,” which in some examples refers to separating a single item from a plurality of items, or and refer to separating a single item from a plurality of the same items. The same items can have a same volume and shape. However, the items may be in an unordered state. Singulation, in some examples, will orient the singulated items in a repeatable orientation, e.g., in a passageway or receptacle configured to receive one item at a time.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations of the systems, algorithms, methods, instructions, etc., described herein may be realized in hardware, software, or any combination thereof. The hardware may include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module may include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module may include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module may include memory that stores instructions executable by a controller to implement a feature of the module.

Further, in one aspect, for example, systems described herein may be implemented using a special purpose computer/processor may be utilized which may contain hardware for carrying out any of the methods, algorithms, or instructions described herein. The hardware may become a special purpose device when storing instructions, loading instructions, or executing instructions for the methods and/or algorithms described herein.

Further, all or a portion of implementations of the present disclosure may take the form of a computer program product accessible from, for example, a computer-usable or computer-readable medium. The program includes steps to perform, at least, portions of the methods described herein. A computer-usable or computer-readable medium may be any device that can, for example, tangibly contain, store, communicate, or transport the program for use by or in connection with any processor. The medium may be, for example, an electronic, magnetic, optical, electromagnetic, or a semiconductor device. Other suitable mediums are also available.

At least some example embodiments of the present disclosure can address human errors in adhering to the treatment regimen. This may reduce the occurrences of adverse events, e.g., overdoses, health danger, complications and possibly deaths, health danger and deaths due to It is believed that some tech-savvy patients have a decreased adherence to a drug treatment regimen. Some embodiments may assist the tech-savvy patients with their adherence.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation to encompass all such modifications and equivalent structure as is permitted under the law.

What is claimed is:

1. A medication dispensing device, comprising:
a housing,
a tray carrying a plurality of pods with interiors that can contain pills, the tray being moveable between an open position where the pods are exposed to a user and a closed position where the pods are not exposed to the user, at least one of the pods being made at least partially of an elastomeric material and including a passage that can open and close in response to the application of a pressing force on the at least one pod,
wherein when the tray is in the open position, the pods are able to be individually opened to either receive pills or to dispense pills, and
a controller that is configured to monitor the insertion of pills into the pods and the dispensing of pills out of the pods.

2. The medication dispensing device as set forth in claim 1, wherein at least one of the pods has a bottom piece that is made of the elastomeric material and a top piece, wherein the bottom piece includes at least one slit, and wherein the bottom piece is configured such that that the application of a downward force on the top piece can cause the at least one slit to open to expose the passage to dispense at least one pill out of the interior of the pod through the passage.

3. The medication dispensing device as set forth in claim 2, wherein the at least one slit in the bottom piece is at least two slits that extend generally perpendicular to one another, and wherein the application of the downward force on the top piece can cause all of the at least two slits to open to expose the passage.

4. The medication dispensing device as set forth in claim 3, wherein the top piece of at least one of the pods is at least partially made of an elastomeric material and includes at least two projections that protrude downwardly into the interior of the pod to engage a sidewall of the bottom piece, and wherein the application of the downward force on the top piece can cause the at least two projections to press on the sidewall of the bottom piece to open the passage.

5. The medication dispensing device as set forth in claim 4, wherein the at least two projections on the top piece includes four projections that have lengths that are configured to dispense one pill out of the passage of the bottom piece per downward force on the top piece.

6. The medication dispensing device as set forth in claim 5, wherein a first pod of the plurality of pods contains a first type of pill and a second pod of the plurality of pods contains a second type of pill that has a different size than the first type of pill, and wherein the projections of the first pod have different lengths than the projections of the second pods.

7. The medication dispensing device as set forth in claim 2, wherein the tray further includes a chute that is positioned vertically below all of the plurality of pods to collect the pills that are dispensed out of the pods.

8. The medication dispensing device as set forth in claim 2, wherein for at least one of the pods, the top piece can be at least partially removed from the bottom piece to present the interior of the pod from vertically above the pod.

9. The medication dispensing device as set forth in claim 1, further including at least one light emitter and including at least one light detector that is in electrical communication with the controller and is configured to detect pill insertion and dispensing events into and out of the plurality of pods.

10. The medication dispensing device as set forth in claim 9, wherein the at least one light emitter and the at least one light detector are positioned vertically below the plurality of pods.

11. A pod for a medication dispensing device, the pod comprising:
a bottom piece made of an elastomeric material and holding a plurality of medications and including at least one slit that can be opened to present a passage;
a top piece that is connected with the bottom piece, the top and bottom pieces enclosing an interior of the pod;
the top piece including a plurality of projections that extend into the interior and contact a sidewall of the bottom piece; and
wherein the top and bottom pieces are configured such that an application of a downward force on the top piece causes the projections to deform the bottom piece to open the slit and present the passage.

12. The pod as set forth in claim 11, wherein the top piece is at least partially made of an elastomeric material.

13. The pod as set forth in claim 11, wherein the at least one slit in the bottom piece includes two slits that extend generally perpendicular to one another.

14. The pod as set forth in claim 11, wherein the top piece can be at least partially removed from the bottom piece to present the interior of the pod from vertically above the pod.

15. The pod as set forth in claim 11, wherein the top piece is at least partially made of an elastomeric material.

16. A method of dispensing medications from a medication dispensing device, comprising the steps of
preparing the medication dispensing device, the medication dispensing device including a plurality of pods that are disposed within a tray, at least one of the pods including;
a bottom piece made of an elastomeric material and holding a plurality of medications and including at least one slit that can be opened to present a passage,
a top piece that is connected with the bottom piece, the top and bottom pieces enclosing an interior of the pod, and
the top piece including a plurality of projections that extend into the interior and contact a sidewall of the bottom piece;
applying a downward force to the top piece such that the projections deform the bottom piece of the at least one pod to open the slit and present the passage; and
automatically dispensing at least one pill out of the at least one pod through the passage.

17. The method as set forth in claim 16, wherein the step of automatically dispensing at least one pill out of the at least one pod through the passage includes singulating and dispensing only a single pill out of the at least one pod through the passage.

18. The method as set forth in claim 16, wherein the top piece is at least partially made of an elastomeric material.

19. The method as set forth in claim 16, wherein the at least one slit in the bottom piece includes two slits that extend generally perpendicular to one another.

20. The method as set forth in claim 16, wherein the tray further includes a chute that is positioned below the plurality of pods to catch the pills dispensed out of the pods.
